(19) United States
(12) Patent Application Publication
(10) Pub. No.: US 2014/0189631 A1
(43) Pub. Date: Jul. 3, 2014

(54) COMPUTER-READABLE RECORDING MEDIUM, CIRCUIT DESIGN APPARATUS AND CIRCUIT DESIGN METHOD

(71) Applicant: FUJITSU LIMITED, Kawasaki-shi (JP)

(72) Inventors: Toshiyasu Sakata, Hino (JP); Takahiko Orita, Kawasaki (JP)

(73) Assignee: FUJITSU LIMITED, Kawasaki-shi (JP)

(21) Appl. No.: 13/966,425

(22) Filed: Aug. 14, 2013

(30) Foreign Application Priority Data
Dec. 27, 2012 (JP) 2012-285743

(51) Int. Cl. G06F 17/50

(52) U.S. Cl. CPC G06F 17/5077
USPC 716/129

(57) ABSTRACT

A computer-readable recording medium having stored therein a program for causing a computer to execute a circuit design process includes: calculating a maximum number of wirings arrangeable in an adjacent region of a part on a board based on a design rule; and drawing the wirings of the maximum number in the adjacent region of the part on the board.

### CROSS-REFERENCE TO RELATED APPLICATION

This application is based upon and claims the benefit of priority of the prior Japanese Patent Application No. 2012-285743 filed on Dec. 27, 2012, the entire contents of which are incorporated herein by reference.

### FIELD

The embodiments discussed herein are related to a computer-readable recording medium storing a circuit design program, a circuit design apparatus, and a circuit design method.

### BACKGROUND

There have been proposed design methods for mounting parts on a printed board. Such design methods obtain arrangement data of the parts on the printed board by calculating indicators associated with easiness of wiring (e.g., wiring density) and determining the arrangement of the parts on the printed board based on the calculated indicators.

Related art is disclosed in Japanese Laid-open Patent Publication No. 2007-150216

However, when a maximum number of wirings that can be arranged in a peripheral region of a certain part on a board are not identified, it is difficult for a designer to immediately determine whether or not the part is properly arranged.

### SUMMARY

A computer-readable recording medium having stored therein a program for causing a computer to execute a circuit design process includes: calculating a maximum number of wirings arrangeable in an adjacent region of a part on a board based on a design rule; and drawing the wirings of the maximum number in the adjacent region of the part on the board.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of a hardware structure of a circuit design apparatus.

FIG. 2 is an example of a structure of mounting Computer-Aided Design (CAD) data and mounting part library data.

FIG. 3 is an example illustrating design rules related to gaps.

FIG. 4 is a flowchart illustrating an example of a process performed by a control unit.

FIG. 5 is an example of a circuit board design diagram display (screen) on a display apparatus.

FIG. 6 is an example of a circuit board design diagram display on a display apparatus.

FIG. 7 is an example of a circuit board design diagram display on a display apparatus.

FIG. 8 is a flowchart illustrating an example of a designated value determining process.

FIG. 9 is an example of a circuit board design diagram display on a display apparatus

### DESCRIPTION OF EMBODIMENTS

Hereafter, examples of embodiments of the present disclosure will be described with reference to the accompanying drawings.

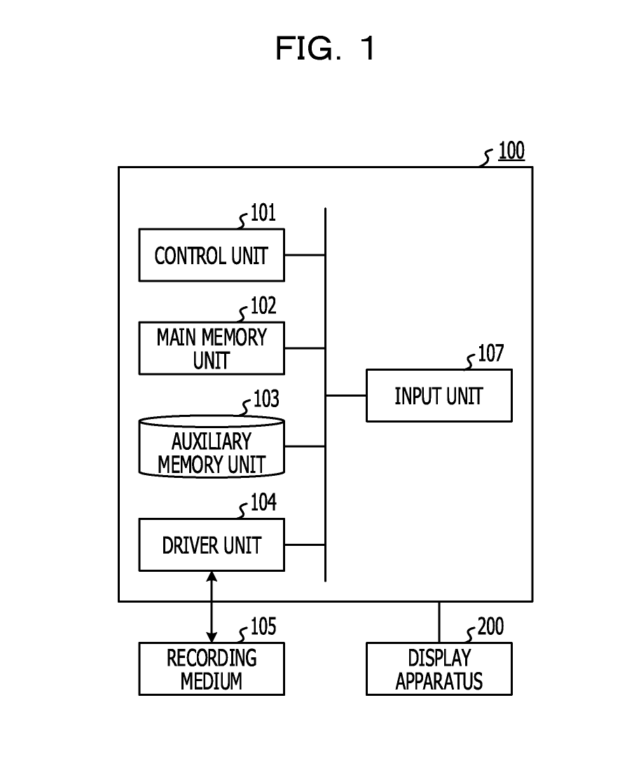

FIG. 1 is an example of a hardware structure of the circuit design apparatus. The circuit design apparatus 100 may be used for, for example, a Printed Circuit Board (PCB) mounting design and the like.

The circuit design apparatus 100 may be implemented by any computer. For example, the circuit design apparatus 100 may be implemented by a computer suitable for CAD. In the example illustrated in FIG. 1, the circuit design apparatus 100 includes the control unit 101, a main memory unit 102, an auxiliary memory unit 103, a driver unit 104, and an input unit 107.

The control unit 101 may be an operation unit (or a processor such as a CPU (Central Processing Unit), an MPU (Micro-Processor Unit), and the like) configured to execute a program stored in the main memory unit 102 or the auxiliary memory unit 103. Upon receiving data from the input unit 107 or a storage unit (e.g., the main memory unit 102 or the auxiliary memory unit 103), the control unit 101 operates and processes the data and then outputs it to the storage unit and the like.

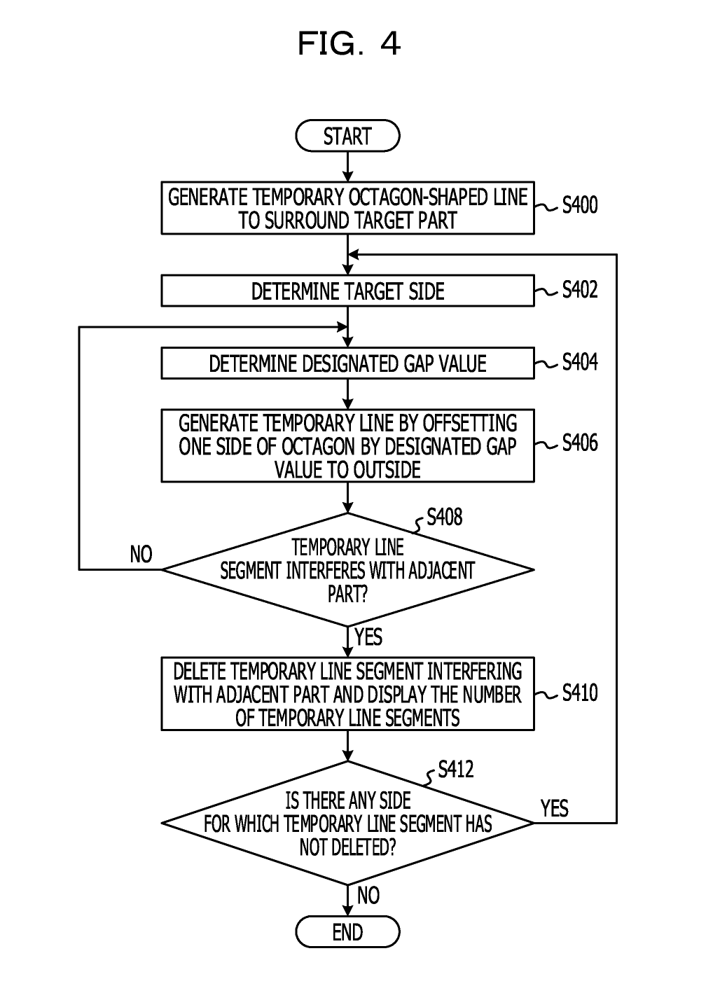

The main memory unit 102 may be a storage unit such as a Read Only Memory (ROM), a Random Access Memory (RAM), and the like, which is configured to record or temporarily store software such as CAD software executed by the control unit 101 and a program (e.g., a program for implementing the process depicted in FIG. 4 which will be described below) or data. The CAD software may include any type of CAD software for circuit design.

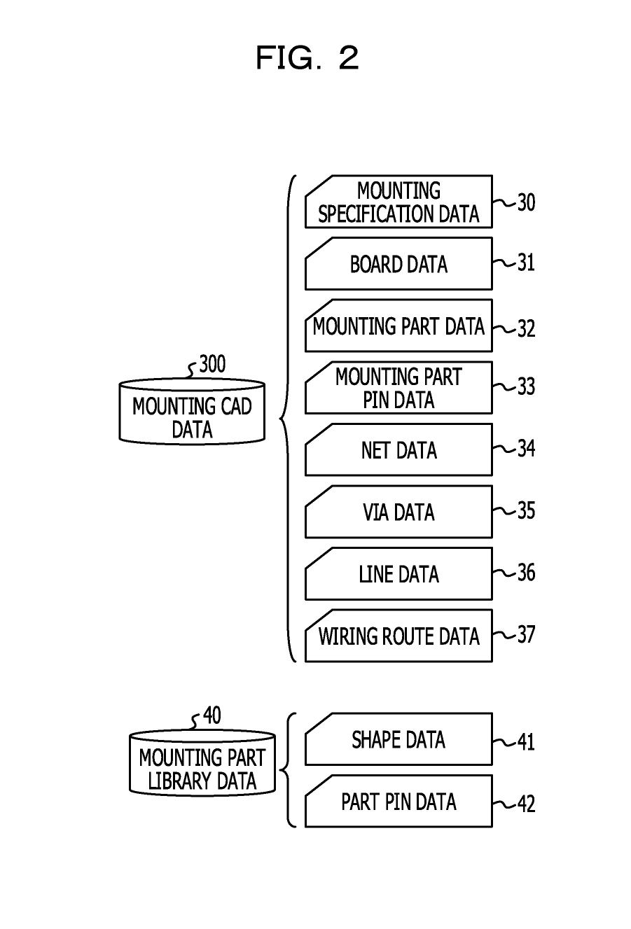

The auxiliary memory unit 103 may be a storage unit such as a Hard Disk Drive (HDD), which is configured to store data related to the CAD software and the like. The mounting CAD data 300 and the mounting part library data 40 (referring to FIG. 2) may be stored in the auxiliary memory unit 103.

The driver unit 104 may read a program from a recording medium 105, for example, a flexible disk, and install the read program in the storage unit.

The recording medium 105 stores a specified program. The program stored in the recording medium 105 (e.g., the program for implementing the process illustrated in FIG. 4 which will be described below) is installed in the circuit design apparatus 100 through the driver unit 104. The installed specified program can be executed by the circuit design apparatus 100.

The input unit 107 includes a keyboard equipped with cursor keys, numeric keys, and other various function keys, a mouse, a touch pad, and the like.

Further, in the example illustrated in FIG. 1, a wiring drawing process or the like, which will be described below, may be implemented by causing the circuit design apparatus 100 to execute the program installed therein. In addition, the wiring drawing process or the like, which will be described below, may also be implemented by recording the program on the recording medium 105 and causing the circuit design apparatus 100 to read the program from the recording medium 105. Furthermore, various types of the recording media, for example, recording media that record information optically, electrically, or magnetically, such as a CD-ROM, a flexible disk, a magneto-optic disc, etc., semiconductor memories that record information electrically, such as a ROM, a flash memory, etc., and the like can be used as the recording medium 105. The recording medium 105 includes no carrier wave, either. Further, the program may be downloaded into the storage unit (e.g., the auxiliary memory unit 103) in the circuit design apparatus 100 via wired or wireless communication with an external device.

A display apparatus 200 is connected to the circuit design apparatus 100. The display apparatus 200 may be, for example, a liquid crystal display, an organic electroluminescence (EL) display, or the like. The display apparatus 200 displays based on an image signal generated by the circuit design apparatus 100. The display apparatus 200 may also display a circuit board design diagram. The circuit board design diagram display may be a display related to a circuit board design diagram at the stage of designing or a display related to a circuit board design diagram after completing designing (i.e., a production diagram).

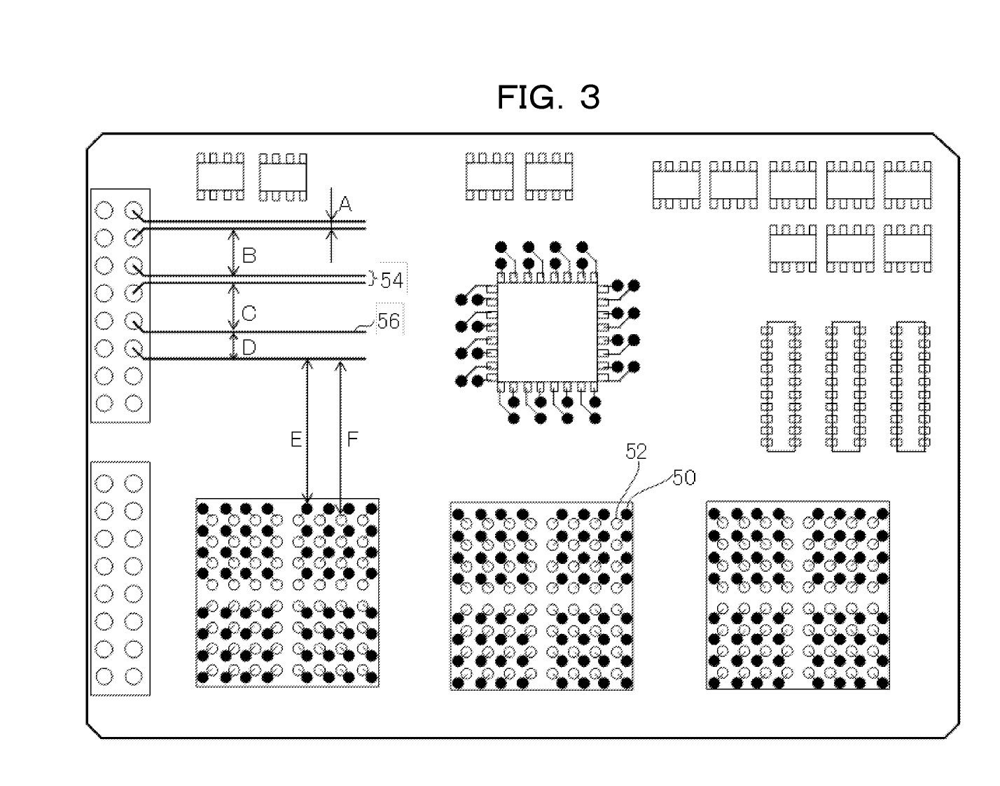

FIG. 2 is an example of a structure of a mounting CAD data and a mounting part library data. FIG. 3 is an example illustrating design rules related to gaps.

In the example illustrated in FIG. 2, the mounting CAD data 300 includes mounting specification data 30, board data 31, mounting part data 32, mounting part pin data 33, net data 34, via data 35, line data 36, and wiring route data 37. The mounting part library data 40 includes shape data 41 and part pin data 42.

The mounting specification data 30 may include a board name and a design rule. The board name may be a name specifying a target board on which parts are mounted and wired. The design rule may include a wiring-related design rule. For example, as illustrated in FIG. 3, the design rule includes a rule of gap between wirings and a rule of a wiring width. The gap-related rule may include a gap A in a differential pair (i.e., a gap between a negative signal transmission line and a positive signal transmission line), a gap B between differential pairs, a gap C between a line and a differential pair, a gap D between lines, a gap E between a line and a via, and a gap F between a line and a part pin. Lower limit values may be set for these gaps A to F. Further, in FIG. 3, reference numeral 50 indicates a via (a virtual lead-out via which will be described below), reference numeral 52 indicates a pin, reference numeral 54 indicates a differential pair, and reference numeral 56 indicates a line (a wiring not forming a differential pair). The differential pair includes a negative signal transmission line and a positive signal transmission line through which signals of opposite phases (i.e., inverted into positive and negative phases) are transmitted to enhance noise-resistance.

The board data 31 may include a number of layers, an external shape, and a thickness of the board. The thickness of a board may include a thickness of a signal layer and a thickness of an inter-layer-insulating layer. If the board is not a multi-layered board, the number of layers in the board may be either omitted or set to “1.”

The mounting part data 32 may include a name of a part to be mounted on the board (a part name), a part library name, a mounting surface, and an arrangement coordinate. The part library name may be associated with the shape data 41 in the mounting part library data 40.

The mounting part pin data 33 may include a part name, a part pin name, a net number, a coordinate, and a layer number. The part pin name may be associated with the part pin data 42 in the mounting part library data 40. The net number indicates a net number to which each pin belongs.

The net data 34 may include a net number, a net name, and another net number to which a counterpart in a differential pair belongs. The net number may be a number specifying a net. Further, the net indicates a wiring between coupled parts. A unit of the net may be arbitrary. For example, a certain net may not be coupled to other nets. If a certain net number indicates a net number to which a counterpart in a differential pair belongs, a net associated with the net number means a net related to the differential pair (a differential net).

The via data 35 may include a net number to which a via belongs, a coordinate, and a layer number. The via data 35 may also include a via attribute (e.g., the presence of a back drill, etc.).

The line data 36 may include a net number to which a wiring belongs, a wiring coordinate (e.g., coordinates of a start point and an end point), a line width, and a layer number. Further, the data included in the line data 36 is data related to a wiring which has already been designed.

The wiring route data 37 may include a wiring route number, a wiring route name, a coordinate sequence, a layer number, and a net number sequence. A wiring route refers to a wiring route already scheduled for wiring (but not wiring-designed yet). The wiring route may be a route of a group of wirings. Further, since the wiring route is the wiring route not wiring-designed yet, it is a rough route (rough path). “Sequence” in the terms “coordinate sequence” and “net number sequence” means that there are a plurality of coordinates and a plurality of net numbers in association with a plurality of wirings constituting the wiring route.

The shape data 41 may include a shape of a part and a height of a shape.

The part pin data 42 may include a pin name of a part, a signal classification and a coordinate. The signal classification may include a high speed signal level and so on.

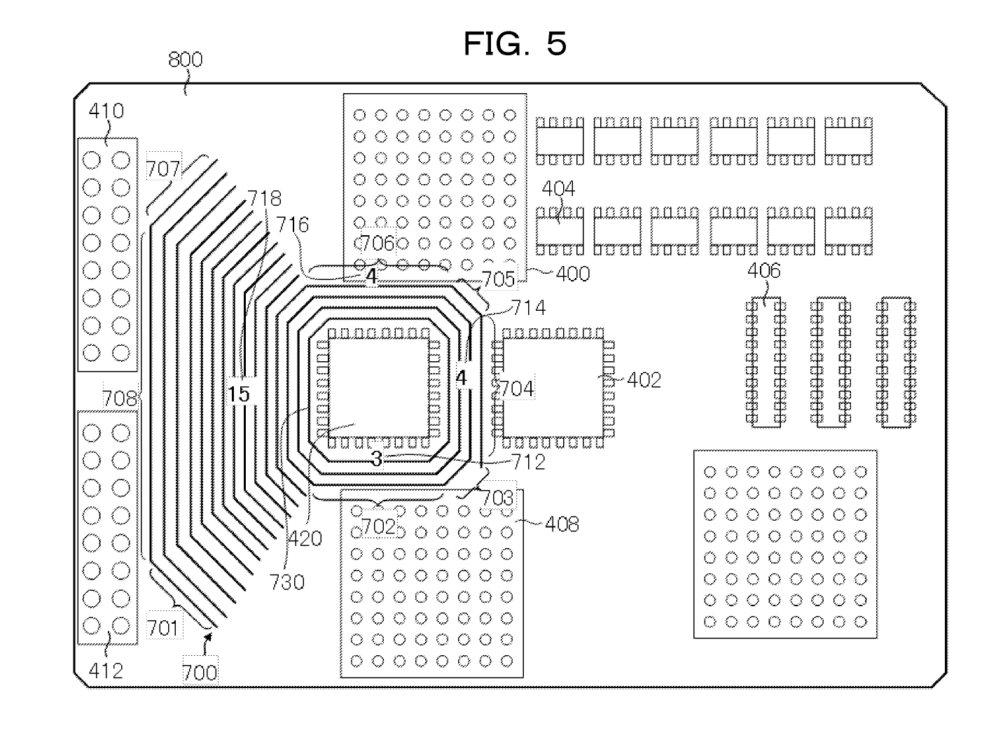

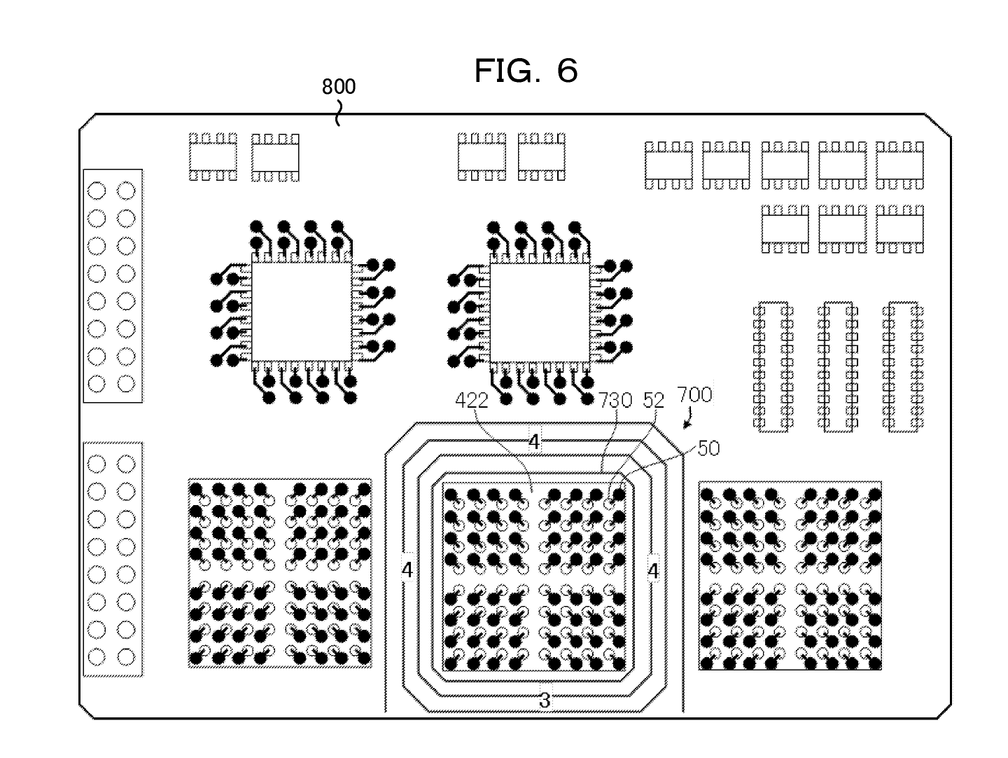

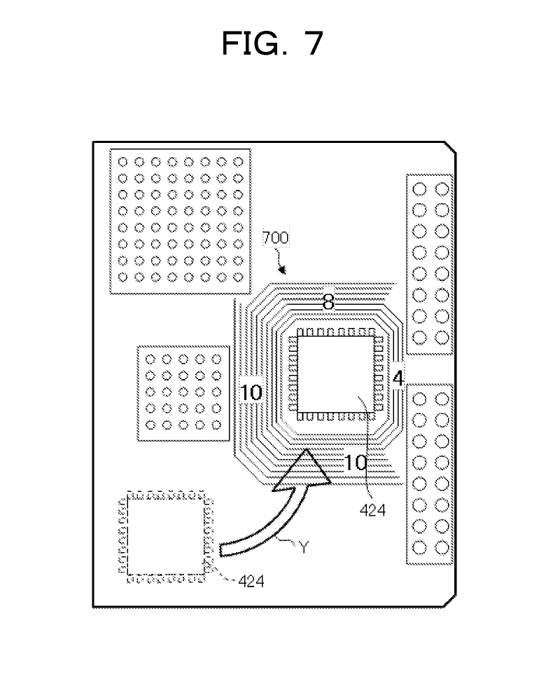

FIG. 4 is a flowchart illustrating an example of a process performed by a control unit. The control unit 101 may be included in the circuit design apparatus 100 illustrated in FIG. 1. A program to perform this process (one example of a circuit design program) may be embedded in a portion of CAD software executed by the control unit 101, may be another program executed in association with the CAD software, or may be a program executed independent of the CAD software. FIG. 5 is a diagram illustrating an example of a circuit board design diagram display on a display apparatus. The display apparatus 200 may be included in the circuit design apparatus 100 illustrated in FIG. 1. The circuit board design diagram display illustrated in FIG. 5 includes temporary line segments 700 (which will be described below) drawn by the process of FIG. 4. In the example of FIG. 5, various kinds of parts 400, 402, 404, 406, 408, 410, and 412 are mounted on a board 800. FIG. 6 is a diagram illustrating another example of a circuit board design diagram display on a display apparatus. The display apparatus 200 may be included in the circuit design apparatus 100 illustrated in FIG. 1. Similarly, the circuit board design diagram display illustrated in FIG. 6 includes temporary line segments 700 (which will be described below) drawn by the process of FIG. 4. In addition, the board design diagram displays illustrated in FIGS. 5 and 6 (and likewise in FIG. 7 which will be described below) may be a display for any layer in the board 800 (e.g., a layer chosen by a user). In this case, as illustrated in FIG. 5 and the like, the mounting parts (part 400, etc.) mounted on the surface of the board 800 may be displayed in an overlapping manner according to choice by the user.

At an operation S400, a temporary octagon-shaped line to surround a target part is generated. In the example illustrated in FIG. 5, it is assumed that the part 420 is the target part. As the part 420 is in the form of a square, the temporary octagon-shaped line includes four main sides (top, bottom, left, and right sides) and four additional sides between the four main sides. The octagon may be changed to any other polygons according to the shape of a part. The temporary octagon-shaped line generated in the operation S400 is a temporary octagon-shaped line closest to the target part 420, which is indicated by reference numeral 730 in FIG. 5. In the following description, the temporary octagon-shaped line generated in the operation S400 is referred to as a “first temporary octagon-shaped line.”

The first temporary octagon-shaped line may be generated according to a design rule. For example, the first temporary octagon-shaped line may be generated by an offset from a via or a pin associated with the target part by a larger one of the gap E between a line and a via (referring to FIG. 3) and the gap F between a line and a part pin (referring to FIG. 3) based on the mounting specification data 30. A position of a via for the target part (i.e., a lead-out via) may be a prediction-based position (or coordinate). This is because the via for the target part may be designed after arrangement of the target part is determined. In the following description, the via with the prediction-based position is referred to as a “virtual lead-out via.” A method of setting a position of the virtual leading-out via (a virtual method) may be arbitrary. For example, in the example depicted in FIG. 6, each virtual lead-out via 50 is set at a position apart in a direction radially extending from the part of the lead-out source by a certain distance from a part pin 52 of a lead-out source.

In the example of FIG. 6, the first temporary octagon-shaped line 730 is generated in such a manner that an offset amount from a target part 422 is minimized, with the line 730 spaced by the gap F or more from each part pin 52 of the target part 422 and spaced by the gap E or more from each virtual lead-out via 50 of the target part 422. In addition, although FIG. 6 illustrates the example in which both the part pin 52 and the virtual lead-out via 50 are considered, one of them may be selectively considered. If neither the part pin 52 nor the virtual lead-out via 50 is considered, the first temporary octagon-shaped line may be formed by an offset from an external shape of the target part 422 by a certain distance based on the shape of the target part 422 (referring to the shape data 41).

In addition, among the temporary line segments of the eight sides forming the first temporary octagon-shaped line, a temporary line segment interfering with a part that is adjacent to the target part may be deleted. Similarly, existence of an interference between the temporary line segment and a part adjacent to the target part may be determined based on whether or not the temporary line segment can be spaced from a part pin associated with the part adjacent to the target part by the gap F or more and can be spaced from a virtual lead-out via associated with the part adjacent to the target part by the gap E or more. Further, among the temporary line segments of the eight sides forming the first temporary octagon-shaped line, a temporary line segment falling within a certain distance from an edge of the board 800 may be deleted. This can be substantially equally applied to other temporary line segments, which will be described below.

At an operation S402, one of the eight sides of the first temporary octagon-shaped line is determined as a target side. In addition, if there exists an already deleted one of the temporary line segments of the eight sides forming the first temporary octagon-shaped line, the target side is determined except for the corresponding side. In addition, since every side is to be determined as a target side in turn except for the side in which the already deleted temporary line segment exists, how to determine the target side may be arbitrary.

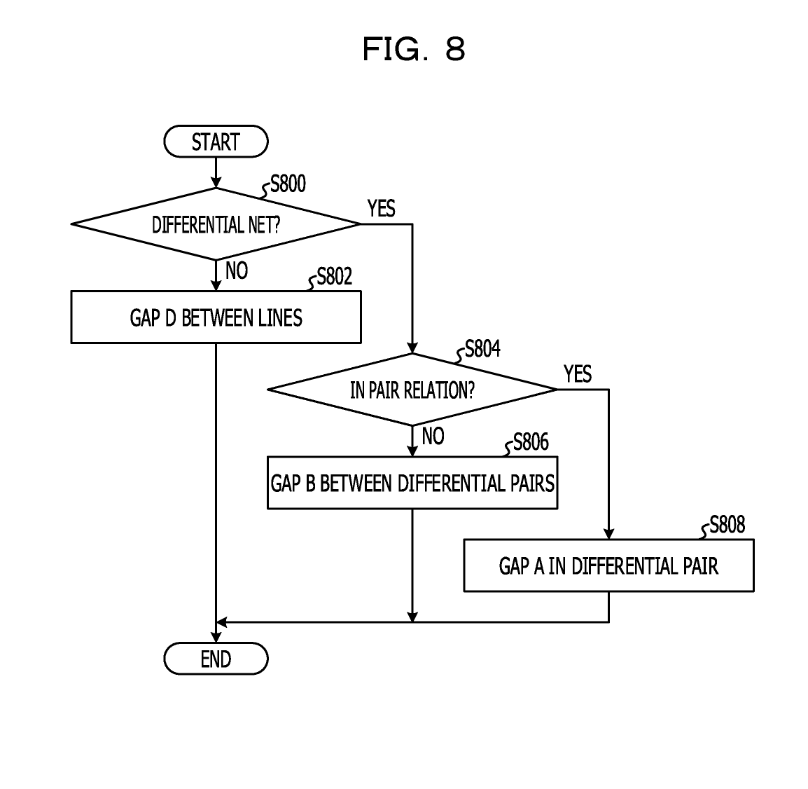

At an operation S404, a designated gap value is determined. The designated gap value may be a fixed value (e.g., the gap D between lines) predetermined based on a design rule. In this case, the fixed value needs to be read in the operation S404. Alternatively, the designated gap value may be variable. How to determine the variable designated gap value will be described below with reference to FIG. 8.

At an operation S406, a new temporary line segment is generated by offsetting the temporary line segment corresponding to the target side, among the temporary line segments of the eight sides forming the first temporary octagon-shaped line, to the outside based on the designated gap value determined in the operation S404. In this case, the offset may involve not only a movement but also a copy (for example, the temporary line segment of an offset source is not deleted). Here, the offset temporary line segment corresponding to the target side is the outermost temporary line segment at this point in time. The term “outside” is based on a direction when the target part is viewed as a center.

At an operation S408, it is determined whether or not the temporary line segment generated in the step S406 interferes with a part adjacent to the target part. Similar to the above, the existence of an interference between the temporary line segment and the part adjacent to the target part may be determined based on whether or not the temporary line segment can be spaced from a part pin associated with the part adjacent to the target part by the gap F or more and can be spaced from a virtual lead-out via associated with the part adjacent to the target part by the gap E or more (refer to FIG. 6). However, as described above, one of the part pin and the virtual lead-out via may be selectively considered. Further, the presence of the interference may be determined based on a shape of the adjacent part (referring to the shape data 41). If it is determined that the temporary line segment interferes with the adjacent part of the target part, the process proceeds to an operation S410. Otherwise, the process returns to the operation S404. Thus, temporary line segments are sequentially generated by an offset to the outside by the designated value until a temporary line segment interferes with the adjacent part of the target part at the target side.

At the operation S410, the temporary line segment interfering with the adjacent part is deleted and a number indicative of the number of finally generated temporary line segments is displayed. The number of finally generated temporary line segments is counted including the temporary line segments forming the first temporary octagon-shaped line. For example, in the example of FIG. 5, a total of three temporary line segments 702 is drawn for the bottom side and accordingly, a line number indication 712 representing “3” is drawn. In addition, for this side, a fourth temporary line segment is deleted since it interferes with the adjacent part 408. For the right side, a total of four temporary line segments 704 is drawn and accordingly, a line number indication 714 representing “4” is drawn. In addition, for this side, a fifth temporary line segment is deleted since it interferes with the adjacent part 402. For the top side, a total of four temporary line segments 706 is drawn and accordingly, a line number indication 716 representing “4” is drawn. In addition, for this side, a fifth temporary line segment is deleted since it interferes with the adjacent part 400. For the left side, a total of fifteen temporary line segments 708 is drawn and accordingly, a line number indication 718 representing “15” is drawn. In addition, for this side, a sixteenth temporary line segment is deleted since it interferes in the adjacent parts 410 and 412. Although the line number indications 712, 714, 716, and 718 are drawn for the main four sides in the example of FIG. 5, the same number indications may be drawn for the other four sides between these main four sides (i.e., the four sides corresponding to the four right angles of the square-shaped target part). Further, the number indications 712, 714, 716, and 718 may be displayed at any positions in association with the corresponding temporary line segments 702, 704, 706, and 708. For example, the number indications 714 and 718 may be displayed within the corresponding temporary line segments 704 and 708, while the number indications 712 and 716 may be displayed above the corresponding temporary line segments 702 and 706.

At an operation S412, it is determined whether or not there exist one or more sides with no deleted temporary line segments, among the eight sides forming the temporary octagon-shaped line, for example, there exist one or more sides which have not been set as a target side. If it is determined that there exist one or more sides with no deleted temporary line segments, the process returns to the operation S402 where a new target side is decided among the sides with no deleted temporary line segments. Thus, for each of the eight sides forming the temporary octagon-shaped line, temporary line segments that are sequentially offset from the first temporary octagon-shaped line to the outside are consecutively generated. If there exists no sides with no deleted temporary line segments, for example, if every side has been set as a target side, the process terminates.

In addition, the temporary line segments generated in the process illustrated in FIG. 4 may be displayed (drawn) on the display apparatus 200 at the stage where all temporary line segments have been generated (for example, the stage where the temporary line segments 700 have been completed). Although some of the temporary line segments are generated and then deleted for the sake of explanation in the above descriptions, such temporary line segments may not be generated from the beginning.

According to the process illustrated in FIG. 4, temporary line segments are generated in the form of an octagon to surround the target part. In this case, the temporary line segments are generated such that the octagons extend to the outside sequentially with gaps of a designated value therebetween (for example, to be sequentially offset to the outside). For example, the temporary line segments are sequentially generated such that the outermost octagon, which has been generated already, is surrounded. Finally, these temporary line segments are generated within a range that does not interfere with adjacent parts. For example, a plurality of temporary line segments is generated until interfering with an adjacent part and the temporary line segment interfering with the adjacent part is deleted. Accordingly, these temporary line segments represent the maximum number of wirings that can be arranged within an adjacent region of the target part. For example, in the example illustrated in FIG. 5, the temporary line segments 700 generated by the process of FIG. 4 represent the maximum number of wirings that can be arranged in adjacent regions of the target part 420 in all directions. In addition, temporary line segments denoted by reference numeral 700 refer to all temporary line segments generated by the process of FIG. 4 for one target part 420. The temporary line segments 702 in the bottom side represent the maximum number of wirings that can be arranged in the lower adjacent region of the target part 420. The temporary line segments 704 in the right side represent the maximum number of wirings that can be arranged in the right adjacent region of the target part 420. The temporary line segments 706 in the top side represent the maximum number of wirings that can be arranged in the upper adjacent region of the target part 420. The temporary line segments 708 in the left side represent the maximum number of wirings that can be arranged in the left adjacent region of the target part 420. This is substantially equally applied to the temporary line segments 701, 703, 705, and 707 in the four sides between the above four sides (for example, the four sides corresponding to the four right angles of the square-shaped target part 420).

The temporary line segments 700 drawn by the process of FIG. 4 are line segments representing the maximum number of wirings (for example, dummy lines) but do not represent wirings drawn by wiring designs. In addition, the temporary line segments 700 drawn by the process of FIG. 4 represent neither wirings entering the target part nor wiring led out of the target part, while representing wirings coupled between other parts through the surroundings of the target part (for example, wirings associated with nets between other parts). Further, when the board 800 is a multi-layered board, the temporary line segments 700 may represent the maximum number of wirings that can be arranged in a certain layer (including a front surface of the board 800) designated by a user. In this case, since parts (the target part or adjacent parts) are arranged on the front surface (or back surface) of the board 800, a layer on which the wirings represented by the temporary line segments 700 are to be formed may be different from the part mounting surface. However, since a number of vias may penetrate toward the bottom of the parts, the fact that the associated layers are not the same may not have substantial effect on the calculation of the maximum number of wirings that can be arranged. Accordingly, the fact that the associated layers are not the same may not be considered in the process described in FIG. 4. In this case, the adjacent region of the target part means an adjacent region of the target part in each layer without being limited to the surface on which the target part is mounted. In addition, adjacent parts which may be partially or entirely wired in an inner layer below the target part may not be partially or entirely considered in determining the presence of interference.

However, in recent years, a level of difficulty for wiring has been certainly raised due to large-scaled high densification of circuits. A number of parts including a significantly large number of pins (e.g., including thousands of terminals) are arranged on a printed board and tens of thousands of partitions, in which wirings are to be made, are defined on the printed board, which results in the increased number of layers necessary for the wirings. In addition, due to mechanical constraints and manufacturing cost conditions, in order to complete all wirings with the minimum number of layers in a limited board size, it takes time to determine which layer and paths are used for each of the areas. When arranging parts in PCB mounting design or the like, in some cases, the parts are arranged considering a wiring strategy on how to wire between parts to be arranged on a board, in addition to a circuit configuration, a device structure, heat distribution and so on. In such a wiring strategy, the number of wirings of signal nets which can be wired between parts may be important.

In light of the above, since the temporary line segments 700 representing the maximum number of wirings that can be arranged in the adjacent regions of the target part are displayed by the process of FIG. 4, a designer may easily determine whether or not the arranged position of the target part is proper from the standpoint of wiring aspects (e.g., the number of wirings, etc.) in the adjacent regions of the target part. In the example illustrated in FIG. 5, if six wirings are necessary in the upper adjacent region of the target part 420, it may be easily understood by viewing the number of temporary line segments 706 indicated in FIG. 5 that the currently arranged position of the target part 420 is not proper. Thus, by using the process of FIG. 4, since parts can be arranged while visually confirming the number of wirings of nets between the parts, an arrangement work considering the wiring strategy may be performed in an efficient manner.

In addition, according to the process illustrated in FIG. 4, since the number indications 712, 714, 716, and 718 representing the number of wirings that can be arranged (for example, the maximum number) are displayed in addition to the temporary line segments 700 representing the maximum number of wirings that can be arranged, a designer can easily obtain the number of wirings without counting the number of temporary line segments 700 one by one. However, the number indications 712, 714, 716, and 718 may be omitted. In addition, the number indications 712, 714, 716, and 718 may be output according to a selection by a user. Similarly, the temporary line segments 700 representing the maximum number of wirings that can be arranged may be output according to a selection by the user.

In addition, the process routine of FIG. 4 may be initiated when the target part is designated by a user (for example, a designer). In this case, the temporary line segments 700 for the designated target part are generated. Further, the designation of the target part may be implemented in an arbitrary aspect through the input unit 107 or the like. For example, the designation of the target part may be implemented by moving a pointer onto the target part and pressing a mouse button. Alternatively, the designation of the target part may be automatically implemented. For example, when the designer changes an arrangement of a certain part or arranges a new part, the process routine described in FIG. 4 may be initiated with the part that is automatically designated as the target part. In this case, as schematically illustrated in FIG. 7, the temporary line segments 700 for the moved or newly arranged target part are generated. In the example of FIG. 7, when a part 424 is moved as indicated by an arrow Y, which is used for explanation, the temporary line segments 700 are drawn for the new position of the moved part 424. In addition, the temporary line segments 700 may be generated and drawn in real time while the part 424 is being moved (tracked).

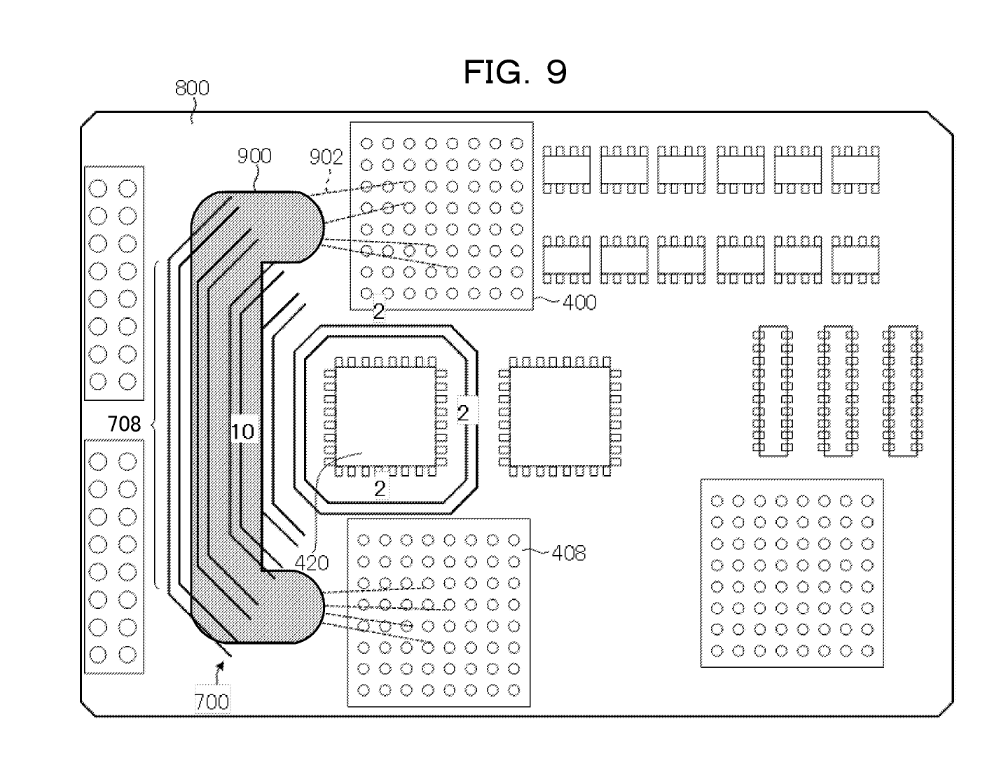

FIG. 8 is a flowchart illustrating an example of a designated value determining process. The designated value determining process may be the operation S404 in FIG. 4. As described above, the designated value determining process illustrated in FIG. 8 is an arbitrary process to be performed as necessary. For example, the designated value determining process of FIG. 8 is not performed in a configuration having no wiring route data 37. In this case, a fixed value (e.g., the gap D between lines) may be used as the designated value. FIG. 9 is a diagram illustrating an example of a display of a circuit board design diagram display on a display apparatus. The display apparatus may be the display apparatus 200 illustrated in FIG. 1. The circuit board design diagram display illustrated in FIG. 9 includes the temporary line segments 700 drawn by the process of FIG. 4 including the designated value determining process described in FIG. 8. In addition, in FIG. 9, the members indicated by reference numerals 900 and 902 virtually represent wiring routes, which are not actually indicated on the screen.

At an operation S800, it is determined based on the wiring route data 37 and the net data 34 whether or not a wiring route exists that constitutes a differential net around the target part. In this case, it may be determined whether or not such a wiring route exists that constitutes a differential net in an adjacent region corresponding to a target side (a region where temporary line segments are generated in association with the target side). In addition, when the net number of a certain wiring route in the wiring route data 37 includes a net number to which a counterpart in a differential pair belongs, the wiring route becomes a wiring route constituting a differential net. Accordingly, at the operation S800, it is determined whether or not wiring of a differential pair is to be arranged in the adjacent region corresponding to the target side. If a wiring route exists that constitutes a differential net around the target part, the process proceeds to an operation S804. Otherwise, the process proceeds to an operation S802.

At the operation S802, the gap D between lines is determined as a designated value. Thus, if wiring of the differential pair is not to be arranged in the adjacent region corresponding to the target side, the gap D between lines is determined as the designated value.

At the operation S804, it is determined whether or not a temporary line segment to be now generated and a current outermost temporary line segment are in a relation of a differential pair. If the temporary line segments are in the relation of a differential pair with the current outermost temporary line segment, the process proceeds to an operation S808. Otherwise, the process proceeds to an operation S806.

At the operation S806, the gap B between differential pairs (refer to FIG. 3) is determined as the designated value.

At the operation S808, the gap A in a differential pair (refer to FIG. 3) is determined as the designated value.

Thus, the designated value determining process illustrated in FIG. 8 may be performed every time one temporary line segment is generated for each target side. This is because the gap B between differential pairs is different from the gap A in a differential pair. However, since a differential pair is a set of two lines, two temporary line segments may be generated as a set. In this case, a temporary line segment for a line in the differential pair generated by offsetting from the first temporary octagon-shaped line (for example, a temporary line segment which is paired with the temporary line segment in the first temporary octagon-shaped line so as to constitute a set at the innermost side) is drawn to be spaced by the gap A from the temporary line segment in the first temporary octagon-shaped line. Then, another set of two temporary line segments (a differential pair) may be drawn to be spaced by the gap B between the sets. In this case, the designated value determining process illustrated in FIG. 8 may be performed for each target side.

In addition, since the designated value determining process of FIG. 8 is performed for each target side, a gap between temporary line segments 700 may be different according to the target sides. In this case, each octagon of the temporary line segments 700 (except for the first temporary octagon-shaped line) may have an unclosed shape due to the gap difference. In one embodiment, although the unclosed shape may be sufficient, this gap difference may be absorbed by temporary line segments for the four sides between the main four sides (for example, the four sides corresponding to the four right angles of the square-shaped target part). In this case, the designated value determining process illustrated in FIG. 8 may be performed when the four main sides (the top, bottom, right, and left sides) become target sides, but may not be performed when the four sides other than the four main sides (for example, the four sides corresponding to the four right angles of the square-shaped target part) become target sides. In this example, when the four sides other than the four main sides become target sides, the designated gap value is unnecessary, and temporary line segments for the four sides other than the four main sides may be generated in a manner to interconnect corresponding end points of adjacent temporary line segments in the four main sides.

In the example depicted in FIG. 9, a wiring route (a rough path) constituting a differential net is indicated by a hatched range 900. This wiring route means that four sets of differential pairs 902 are coupled between the part 400 and the part 408 through the left adjacent region of the target part 420. In this case, as illustrated in FIG. 9, the temporary line segments 708 are drawn in the left adjacent region of the target part 420 to be spaced by the gap A from each other in differential pairs and by the gap B from each other between the differential pairs. In addition, in the example of FIG. 9, although the wiring route just passes through the left adjacent region of the target part 420, the temporary line segments 700 are drawn throughout the entire adjacent regions of the target part 420 according to designated gap values relating to the differential pairs. In this manner, if a wiring route exists that constitutes a differential net on any one of the entire adjacent regions of the target part 420, the temporary line segments 700 may be drawn throughout the entire adjacent regions of the target part 420 according to the designated gap values relating to the differential pairs. In this case, the designated value determining process illustrated in FIG. 8 may be performed for each target part 420.

By using the designated value determining process of FIG. 8, it is possible to properly generate and draw the temporary line segments 700 representing the maximum number of wirings that can be arranged depending on whether or not wiring of a differential pair is to be arranged around the target part. This allows proper temporary line segments 700 to be drawn depending on attributes of expected wirings around the target part.

While various embodiments have been described above, the present disclosure is not limited to these particular embodiments but may be modified and altered in different ways without departing from the scope defined by the claims. In addition, some or all of the elements of the above-described embodiments may be used in combination.

For example, although it has been illustrated in the above embodiments that the temporary line segments 700 are drawn in the form of an octagon including the temporary line segments associated with the four sides other than the four main sides in consideration of a shape of wiring patterns, they may be more simply drawn in the form of a square coupling the temporary line segments associated with the four main sides taking into consideration that the purpose of the display is design support (they do not represent actual wiring patterns). In addition, the temporary line segments 700 need not necessarily have a polygonal shape but may be drawn as a shape with a radius of curvature (for example, a shape including a curved portion).

In addition, although it has been illustrated in the above embodiments that temporary line segments are generated based on the determination on whether or not all of the eight sides interfere with adjacent parts in association with the shape of an octagon, the interference with the adjacent parts may be determined for only the four main sides (the top, bottom, right, and left sides). For example, in the process of FIG. 4, only the four main sides (the top, bottom, right, and left sides) may serve as target sides. In this case, the temporary line segments for the four sides other than the four main sides may be drawn by coupling corresponding end points of adjacent temporary line segments for the four main sides.

In addition, although it has been illustrated in the above embodiments that the temporary line segments 700 are drawn to surround all four sides of the target part, the temporary line segments 700 may be drawn to surround one, two, or three sides among the four sides of the target part. For example, if the temporary line segments 700 are to be drawn to surround one of the four sides of the target part, they may be generated by sequentially offsetting the temporary line segment corresponding to the one side, among the temporary line segments of the eight sides constituting the first temporary octagon-shaped line, to the outside, as in the above-described embodiments. On the other hand, temporary line segments except the temporary line segments corresponding to the one side are deleted (or are not generated from the beginning). In this case, as can be seen also from FIG. 5, an inner temporary line segment closer to the target part may become shorter than an outer temporary line segment. In contrast, in this case, the temporary line segments 700 may be drawn as the same shape with the same length, may be drawn with individual maximum lengths up to a position at which they interfere with other parts, or may be drawn within a range designated by a user.

Further, although it has been assumed in the above embodiments that each part is mounted on the front surface (or back surface) of the board 800, the part may be mounted on an inner layer of the board 800 using, for example, a built-up method. In addition, although it has been assumed in the above embodiments that vias pass through the board 80, they may be formed, for example, as Interstitial Via hole (IVH).

Furthermore, in the above embodiments, if attributes of expected wirings around the target part are predetermined, the temporary line segments 700 may be drawn to have line widths corresponding to the attributes.

In addition, in the above embodiments, various data in the mounting CAD data 300 and the mounting part library data 40 are merely examples. Accordingly, some of the data may be omitted or other data may be added as necessary. Further, various data 30 to 37, 41, and 42 are classified as an example and may be used properly in combination or separately.

According to the present disclosure, it is possible to provide a circuit design program which is capable of displaying a maximum number of wirings that can be arranged in an adjacent region of a part on a board.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium having stored therein a program for causing a computer to execute a circuit design process comprising:
calculating a maximum number of wirings arrangeable in an adjacent region of a part on a board based on a design rule; and
drawing the wirings of the maximum number in the adjacent region of the part on the board.

2. The computer-readable recording medium of claim 1, wherein the design rule includes a gap between wirings.

3. The computer-readable recording medium of claim 2, wherein the design rule includes at least one of a first gap between a wiring and a part pin and a second gap between a wiring and a via.

4. The computer-readable recording medium of claim 2, wherein the gap between wirings is set for each of wiring attributes.

5. The computer-readable recording medium of claim 4, wherein the wiring attributes include a differential pair wiring.

6. The computer-readable recording medium of claim 1, further comprising, drawing the calculated maximum number.

7. The computer-readable recording medium of claim 1, wherein the wirings are a wiring not-coupled to the part and are drawn so as to surround at least a portion of the part.

8. The computer-readable recording medium of claim 7, wherein the wirings of the maximum number are drawn in the form of an octagon.

9. The computer-readable recording medium of claim 1, wherein the maximum number of wirings is calculated for each of adjacent four sides of the part.

10. The computer-readable recording medium of claim 1, further comprising, determining an attribute of a wiring to be arranged in the adjacent region of the part,
wherein the maximum number of wirings is calculated based on the design rule corresponding to the determined attribute of the wiring.

11. The computer-readable recording medium of claim 1, further comprising:
calculating the maximum number of wirings when the part is designated; and
drawing the wirings of the maximum number of.

12. The computer-readable recording medium of claim 1, further comprising:
calculating the maximum number of wirings when the part is moved: and
drawing the wirings of the maximum number.

13. A circuit design apparatus comprising:
a memory unit configured to store a design rule; and
a control unit configured to calculate a maximum number of wirings arrangeable in an adjacent region of a part on a board based on the design rule and draw the wirings of the maximum number in the adjacent region of the part on the board.

14. A circuit design method comprising:
calculating, by a computer, a maximum number of wirings arrangeable in an adjacent region of a part on a board based on a design rule; and
drawing the wirings of the maximum number in the adjacent region of the part on the board.
